(19) United States
(12) Patent Application Publication
(10) Pub. No.: US 2005/0113204 A1
(43) Pub. Date: May 26, 2005

(54) Integral input adjuster for tandem drive axles

(76) Inventors: Leo Wenstrup, Portage, MI (US); Mark Rodgers, Augusta, MI (US); Larry Jevnikar, Portage, MI (US); Michael Green, Kalamazoo, MI (US); Gary Turner, Three Rivers, MI (US); Brad Cornell, Augusta, MI (US)

Correspondence Address: Attention: Mark A. Hixon, Esq.;Marshall & Melhorn, LLC, 8th Floor, Four SeaGate, Toledo, OH, 43604, US

(21) Appl. No.: 10/724,267

(22) Filed: Nov. 26, 2003

(51) Int. Cl. F16H 48/06

(52) U.S. Cl. 475/230

(57) ABSTRACT

An input bearing adjuster system includes a differential carrier assembly having a set of threads on an interior surface and an input bearing adjuster having a complementary set of threads on an exterior surface. The system also includes an input bearing system of a differential which includes an outer race in contact with the input bearing adjuster and an inner race in contact with an input shaft and an input bearing. Additionally, a locking mechanism is used to selectively secure the input bearing adjuster to the differential carrier. The threads of the bearing adjuster are engaged with the threads of the differential carrier to adjust both the preload and/or the endplay of the input bearing.

### FIELD OF THE INVENTION

The present invention relates to an improved integral input adjuster for tandem drive axles.

### BACKGROUND OF THE INVENTION

A known input adjuster is found in U.S. Pat. No. 2,120,594 which teaches that the outer end of the differential casing is provided with a cylindrical hub which is piloted in a bearing. The inner race of the bearing abuts a shoulder on the hub and the outer race of the bearing is carried in a circular bore formed by a semi-circular pedestal integral with the carrier and a semi-circular differential bearing cap. The outer race of the bearing abuts a differential bearing adjustment ring which is threadedly inserted into the circular aperture formed by the semi-circular pedestal and cap. The differential bearing cap is removably secured to the semi-circular pedestal of the differential carrier assembly by a nut threaded into a stud contained in the differential carrier.

The above-described design, and similar input adjuster designs, has several disadvantages. In order to adjust input adjuster endplay, shims are positioned about the input cover. These shims are limited in precision, and thus accuracy of the measurements is limited. Additionally, in order to position these shims, the input cover must be unbolted and shims must then be positioned or removed to adjust the input bearing endplay.

### SUMMARY OF THE INVENTION

The present invention defines an input bearing adjuster system. The system includes a differential carrier assembly having a set of threads on an interior surface and an input bearing adjuster having a complementary set of threads on an exterior surface. The system also includes an outer race in contact with the input bearing adjuster and an inner race in contact with an input shaft and an input bearing. Additionally, a locking mechanism is used to selectively secure the input bearing adjuster to the differential carrier. The threads of the bearing adjuster are engaged with the threads of the differential carrier assembly to adjust both the preload and/or the endplay of the input bearing.

### BRIEF DESCRIPTION OF THE DRAWINGS

The above, as well as other advantages of the present invention will become readily apparent to those skilled in the art from the following detailed description when considered in the light of the accompanying drawings in which:

FIG. 1 is an illustration of a known differential assembly for a tandem drive axle; and

FIG. 2 is an illustration of a threaded integral input adjuster for a tandem drive axle according to the present invention.

### DETAILED DESCRIPTION OF THE PREFERRED EMBODIMENTS

It is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions, directions or other physical characteristics relating to the embodiments disclosed are not to be considered as limiting, unless the claims expressly state otherwise.

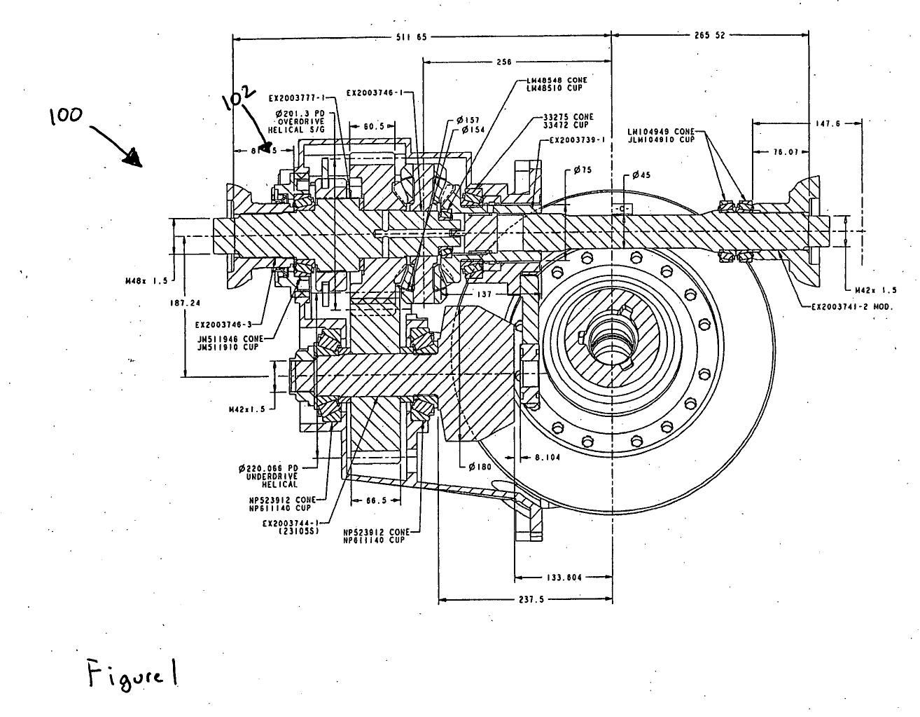

FIG. 1 illustrates a known differential assembly 100 for a tandem drive axle. This figure illustrates a standard bolted cage 102 which is limited as described hereinabove. In a standard tandem axle drive, the forward axle has a power divider system that distributes drive torque between the front and rear drives.

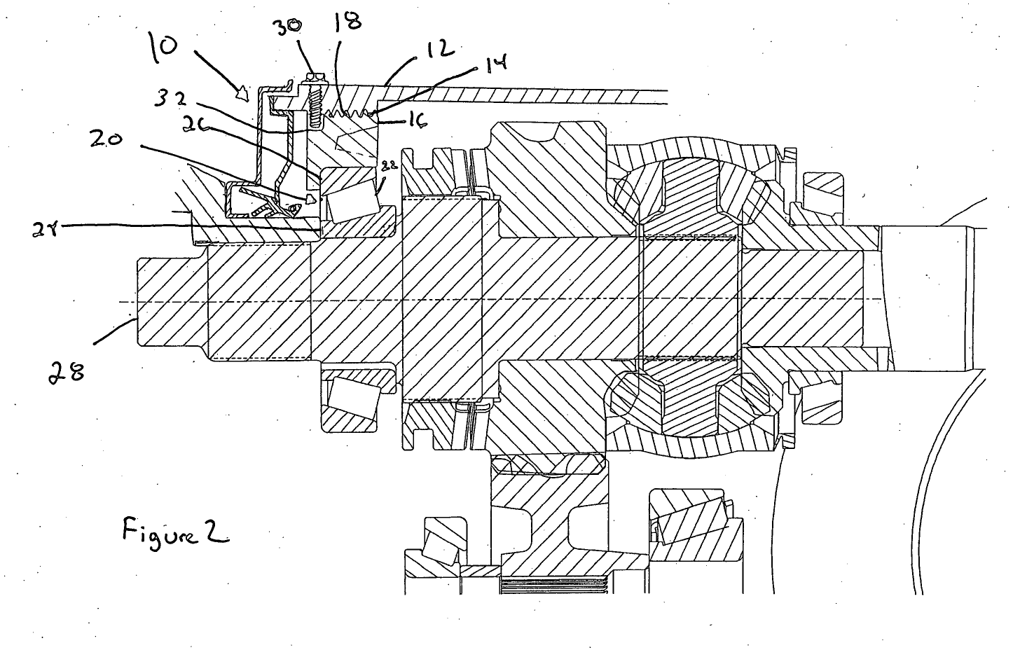

FIG. 2 illustrates an embodiment of the present invention. An input bearing adjuster system 10 includes a differential carrier assembly 12. The differential carrier assembly 12 comprises a set of threads 14 on an inner surface thereof. Adjacent the carrier 12 is an input bearing adjuster (or bearing cup) 16 having a set of threads 18 on an exterior surface. The threads 14 of the differential carrier assembly 12 and the threads 18 of the input bearing adjuster 16 are complementary to and mate with one another.

An input bearing system 20 includes an input bearing 22 and interior 24 and exterior 26 bearing races adjacent thereto. The exterior race 26 is adjacent to and makes contact with the input bearing adjuster 16, and the interior race 24 is adjacent to and makes contact with a shaft 28. The relative positioning of the differential carrier assembly 12 and the input bearing adjuster 16, can be used to adjust the preload and/or the endplay of input bearing system 20. This can be controlled by adjusting the positioning of the threads 14, 18 relative to one another, which moves the adjuster 16 in or out relative to the carrier 12.

The input bearing is used to support the rotating shaft 28 to transfer torque to drive wheels. The bearing 22 is shown in this figure as tapered, but can include, but is not limited to, cylindrical or round.

According to the present invention, a locking mechanism 30 is provided to maintain the positioning of the input bearing adjuster 16 relative to the differential carrier assembly 12. In a preferred embodiment of the present invention, the locking mechanism 30 can be a mechanical structure, such as a screw.

In accordance with the present invention, the position of the input bearing adjuster 16 relative to the differential carrier assembly 12 can be manually adjusted to the needed position. Upon the correct position being established, the locking mechanism 30 can be used to lock the positions relative to one another. Thus, the proper positioning of the input bearing adjuster 16 relative to the differential carrier assembly 12 can be maintained during use. While the use of a screw is depicted and preferred, other mechanical structures could be utilized as the locking mechanism.

In a preferred embodiment of the present invention, the locking mechanism 30 can engage with a slot or groove 32 placed in the input bearing adjuster 16, as shown in FIG. 2. While the groove is depicted as being at the end of the input bearing adjuster 16, the groove 32 could also be positioned away from the end of the input bearing adjuster 16. Alternatively, the locking mechanism 30 can engage the outer surface of the input bearing adjuster 16 without the use of a groove, i.e. engaging the exterior of the bearing adjuster adjacent to the threaded area.

The play of the input bearing adjuster 16 relative to the differential carrier assembly assembly 12 is preferably very small and on the order of millimeters or less. Therefore, if a groove 32 is utilized as discussed above, the tolerance of the groove need not be very large for proper adjustment of the input bearing adjuster 16 relative to the differential carrier assembly assembly 12.

Those skilled in the art recognize that the input bearing 22 rotatably supports the shaft 28. The shaft 28 drives a power divider, which divides a portion of the drive from the input shaft to a first drive axle. An output shaft rotatably connected to the power divider drives a second drive axle located behind the first drive axle. Bearings within the carrier, including the input bearing, rotatably support the above described components. Bearing life and gear mesh are dependent on the preload and the endplay within the system.

The present invention, as described herein, provides the benefits of being easier and more precise in adjusting the input bearing endplay. Existing methods, using shims, are imprecise and require the unbolting of the cover and the addition/removal of shims to adjust the input bearing endplay. Additionally, the present invention produces a reduced cost, as there are fewer parts and a simplified process for the adjustment of the endplay. Specifically, the system, as described herein, can eliminate the need for an endcap, i.e. input cover, over the bearing system, and also eliminates the need for shims for adjusting the endplay. The need for the cover can be eliminated because the threaded adjuster is large enough the interaxle differential, pinion helical gear and side gear can possibly fit through the opening for the input adjuster. Further, the invention can reduce the number of leak paths through the assembly, as shims are not required, and can also reduce the required envelope for the carrier (as space is no longer needed for the bolted input cover.

In accordance with the provisions of the patent statutes, the present invention has been described in what is considered to represent its preferred embodiments. However, it should be noted that the invention can be practiced otherwise than as specifically illustrated and described without departing from its spirit or scope.

1. An input bearing adjuster system comprising:
a differential carrier assembly having a set of threads on an interior surface;
an input bearing adjuster having a complementary set of threads on an exterior surface;
an input bearing system of a differential comprising an outer race in contact with said input bearing adjuster and an inner race in contact with an input shaft and an input bearing; and
a locking mechanism to selectively secure said input bearing adjuster to said differential carrier;
wherein said threads of said bearing adjuster are engaged with said threads of said differential carrier assembly to adjust both the preload and/or the endplay of said input bearing.

2. The input bearing adjuster system according to claim 1, wherein said locking mechanism comprises a screw.

3. The input bearing adjuster system according to claim 1, wherein no endcap is necessary for the differential carrier.

4. The input bearing adjuster system according to claim 1, wherein no shims are necessary to adjust the position of the input bearing adjuster relative to the differential carrier.
